(19) United States
(12) Patent Application Publication
(10) Pub. No.: US 2006/0259643 A1
(43) Pub. Date: Nov. 16, 2006

(54) Signalling system in a signalling point

(76) Inventor: Klaus Gradischnig, Gauting (DE)

Correspondence Address: NEIFELD IP LAW, PC, 4813-B EISENHOWER AVENUE, ALEXANDRIA, VA, 22304, US

(21) Appl. No.: 11/352,230

(22) Filed: Feb. 13, 2006

Related U.S. Application Data
(63) Continuation of application No. 09/673,905, filed on Oct. 23, 2000.

(30) Foreign Application Priority Data
Apr. 22, 1998 (DE) 98 107 336.4

(51) Int. Cl. G06F 15/16

(52) U.S. Cl. 709/250

(57) ABSTRACT

Loops via which a signalling point communicates with itself are advantageous for solving various problems. According to the invention, a loop is enabled by a link that is returned in a loop from a signalling point to the same signalling point and to which two different signalling network identities are allocated at the output and input side.

In channel-related signalling systems, for example in the signalling system R5, it is possible that a signalling point communicates or, respectively, sets up a connection with itself via a payload channel loop. This is not possible in the signalling system ZGS7 (see below). However, such loops are advantageous for solving a number of problems. For the interworking of different signalling systems, it is a critical simplification in the realization when all signalling systems interwork with a selected signalling system and not each with each. Further, such loops are advantageous in order to be able to test systems with high traffic. Finally, monitors can be attached to such loops. Different traffic flows can then be supplied for observation on the basis of purely administrative measures (without hardware re-strapping).

In ZGS7, a signalling point is identified by an address, what is referred to as the signalling point code. The level 3 of the message transfer parts cannot send a message to its own signalling point code or, respectively, cannot receive a message from itself. Certain users of the message transfer part, for example TUP and ISUP, can also normally not send channel-related messages to themselves, even if the message transfer part were to enable this. In order to nonetheless enable such loops, specific methods have been implemented that are essentially comprised therein that specific signalling channels form loops on which destination and/or sender address are inverted/complemented. Similar, user-specific modifications must be potentially implemented for users.

The invention is based on the object or enabling loop formation without said disadvantages.

This object is achieved by a system according to claim 1.

The invention is explained in greater detail below with the assistance of the drawing, whereby the drawing comprises six Figures.

In ZGS7, a network is identified by what is referred to as a network indicator (NI) that is contained in the messages. 2 bits for the NI are reserved in the messages; up to four networks can thus been distinguished from one another in a node (said networks can, for example, be a matter of the signalling networks of communication networks of different operators or different technologies (for example, broadband or narrowband) as well as a matter of national or, respectively, international signalling networks). Since a signalling link normally belongs to only one network, however, the perception has prevailed that allocating individual links to specific networks suffices for distinguishing the network. The NI is thus no longer required as a distinguishing feature.

In fact, there are communication systems that support more than four signalling networks (for example, 8 or 32), for example the EWSD system of Siemens AG, or such systems are being planned. A network identity is thereby internally allocated to each signalling link and an NI is externally allocated to each internal network identity. Networks with different internal identity can thereby definitely use the same external NI. Each (internal) network is thereby completely separated from the other networks.

This concept, what is referred to as the multiple network concept, is then employed for operating loops in ZGS7 without requiring additional development. The signalling system in a signalling point is identified in two (internal) networks by different point codes. These two networks can then be unproblematically connected to one another by signalling links. When a check of the incoming NI for correctness is implemented in the system or, respectively, in at least one of the two networks to be interworked with one another, then the same external NI must also be allocated to the two internal networks. Note: when there is no mapping of incoming linkset onto NI and different networks must be monitored by a single, shared network entity (protocol realization), the NI therefor must be taken to identify the “responsible” network (the applicable routing table). Without a check, for example, it is thereby possible that a message from one network is illegally forwarded into another network due to the employment of an incorrect NI, which can lead to disadvantageous behavior in the other network (this could be referred to as uncontrolled tunneling since it is externally triggered and can no longer be controlled in the node).

Said arrangement is referred to below as network or, respectively, signalling tunnel. Embodiments of the invention are explained in greater detail below.

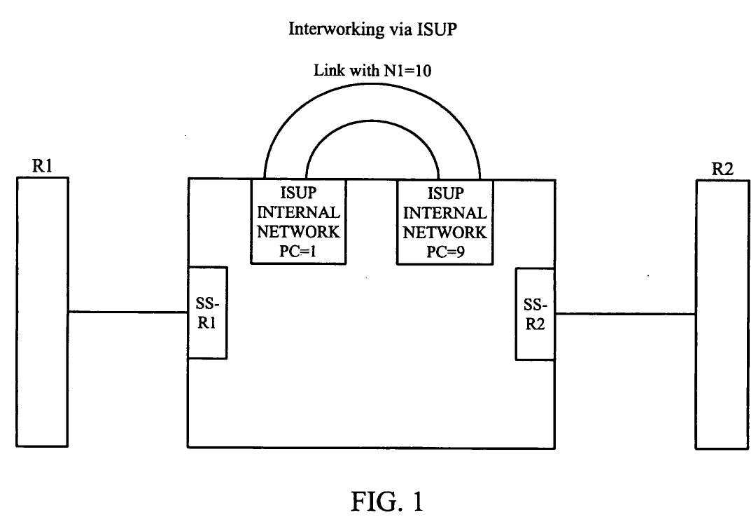

FIG. 1 shows an embodiment of the invention for the interworking in a signalling point.

An ISUP is located both in the internal network 1 as well as 2. Externally, the two networks use the same NI but different point codes. A call between R1 and R2 is routed via the ISUP loop. It suffices for this purpose to correspondingly configure the ZGS7 routing tables in both networks as well as the routing tables for the call processing (R1 and R2 in ISUP) and to accomplish [sic] the necessary trunks and signalling tunnels for the ISUP loop.

An interworking is realized between CCITT signalling system R1 and ISUP as well as between CCITT signalling system R2 and ISUP but not between R1 and R2. A call that is supposed to run from R1 to R2 is first handed over outgoing to the ISUP by the call processing, said ISUP routing the MSU belonging to this connection setup via the signalling tunnel to the ISUP of the other network. Coming from R1, thus, the call is thus first handed over to the ISUP in network 1. Using the called party address signalled by R1, the ISUP determines the next destination with the appertaining DPC (DPC=9), enters this DPC into the MSUs and then hands over these MSUs to the MTP of ZGS7. The MTP takes the DPC from the MSUs and, on the basis of its routing table for network 1, determines the link (a loop link) therefrom via which it further-routes the MSU. The ISUP in network 2 receives the MSUs from the MTP and in turn hands over the MSUs and, thus, the call to the call processing. On the basis of its routing table, the call processing then determines that the call is forwarded via R2.

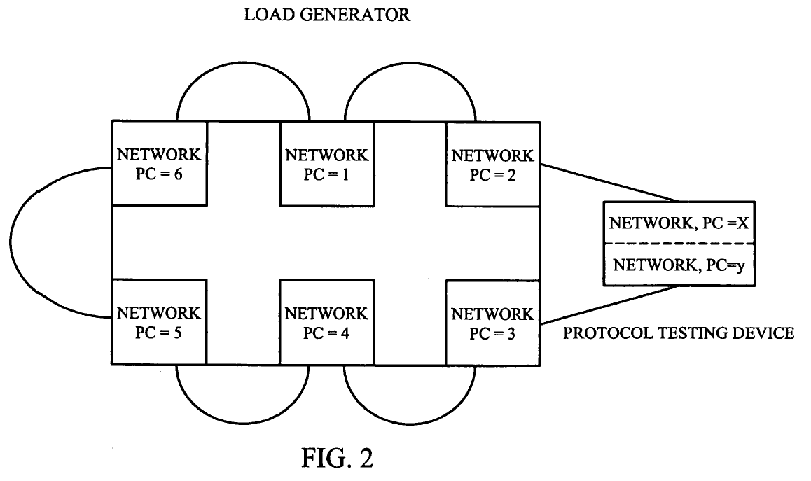

FIG. 2 shows an embodiment of the invention for the load generation.

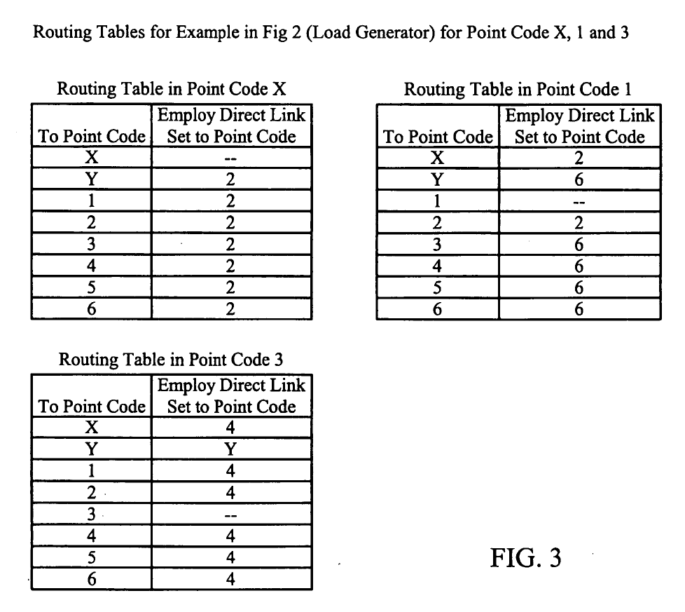

FIG. 3 shows routing tables in the point codes X, 1 and 3 belonging to the embodiment in FIG. 2, i.e. in the different networks of the signalling point supported by the system.

For example, 6 networks are established in the system and cyclically connected to one another by network tunnels. Two networks (networks 2 and 3 here) are also connected to a protocol test device that emulates a point code (X and Y here) in each of the two networks. All networks employ the same NI.

These routing tables in the networks in the system are configured such that network 3 routes MSUs that contain a destination point code PC=X to network 4, and network 4 routes them farther to network 5, etc. The routing tables are analogously configured in the opposite direction for PC=Y. A message generated by the test device is thus routed through the system six times, as a result whereof high system loads can be generated with relatively simple test devices. Further variations of this application are the incorporation of the users (for example, ISUP) or, on the other hand, completely closed loops wherein MSUs constantly circulate.

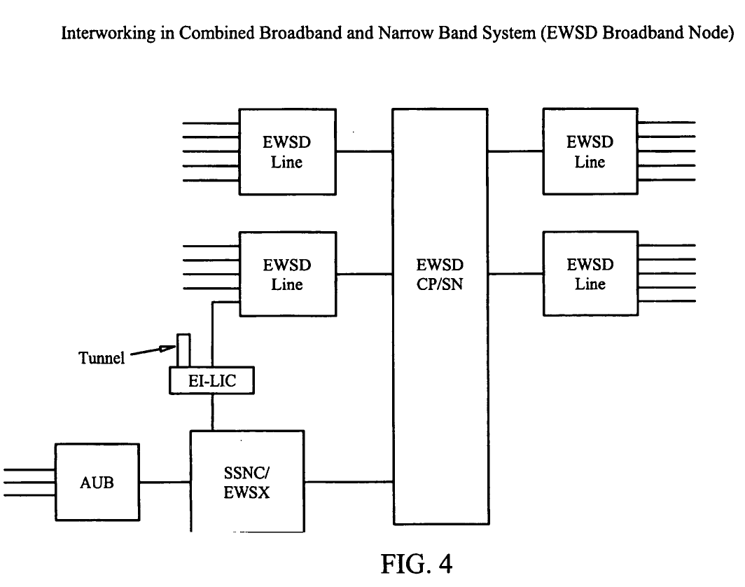

FIG. 4 shows an embodiment of the invention for the interworking in combined broadband and narrowband systems.

The SSNC is the shared MTP platform in the EWSD broadband node. B-ISUP is located only in the EWSX part, N-ISUP in the EWSD and EWSX. In order to enable an NNI (trunk) interworking in the EWSD broadband node bet. broadband and narrowband without additional development, the interworking between N-ISUP in the EWSD and N-ISUP in the system EWSX can be achieved by the described signalling tunnel.

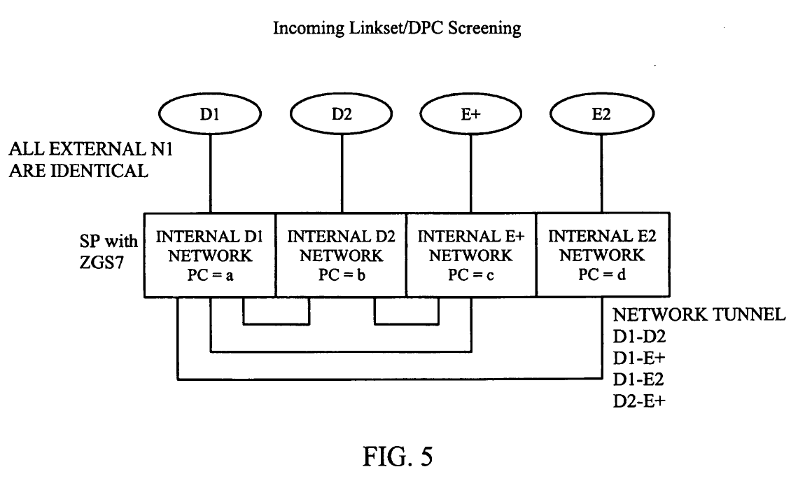

FIG. 5 shows an embodiment of the invention wherein an operator (for example, D1) offers inter-network STP services to a number of other network operators (for example, D2, E+, E2). This exemplary embodiment can be employed for certain practically relevant expressions of the incoming linkset/DPC screening (see Q.706, §8).

D1 should thereby be able to interwork with all other networks, D2 with D1 and E+, E+with D1 and D2, and E2 only with D1. This function can be solved [sic] with a plurality of internal networks connected by tunnels. A separate internal network is thereby allocated to the links to a respective network operator. The individual networks are connected by tunnels in conformity with the allowed signalling relationships. The routing tables in the individual networks are configured in conformity with the allowed relationships.

Alternatively, the traffic between the networks can also be routed via an internal transition network (see the example from FIG. 1). This has the advantage that fewer tunnels are potentially required. On the other hand, traffic between the networks then gotta go through two tunnels. [!!!!!!!!!]It is thereby probable in this embodiment that the internal networks are based on a common external address space, i.e. that there's really only one network externally. In our example, this network would be what is referred to as the network interworking. Seen from the outside, the different internal networks look like separate STP connected to one another according to the rules.

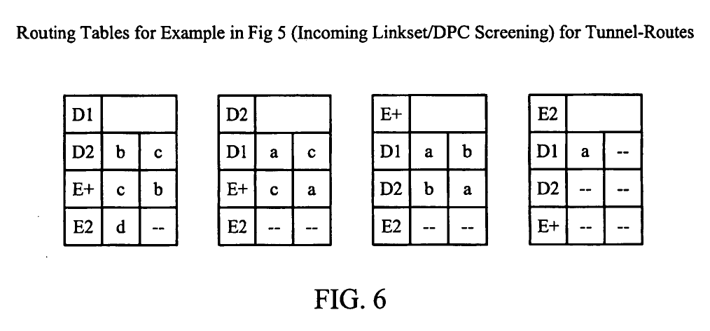

FIG. 6 shows routing tables belonging to the embodiment in FIG. 5.

These routing tables in the four logical internal networks of the signalling point show allowed primary and, potentially, secondary routes to the respectively other networks, whereby these routes are identified by the respectively next point code. The row marked with D2 in the first table, for example, thereby symbolically stands for all destinations (point codes) in D2 that are allowed to be selected proceeding from D1. The direct link(set) to Pc=b is thereby taken as primary route. If this link(set) happens to have failed, the route via PC=c can be taken as secondary route since a route to D2 is also present therefrom. The “external” routes, for example from Pc=a into the D1 network, are not recited here since they're not relevant.

The explained embodiments of the invention have shown that an existing mechanism (“multiple networks”) can be employed without additional outlay for a number of applications as a result of the inventive configuration.

1-10. (canceled)

11. A signaling node for processing signaling messages, comprising:
(a) links via which the signaling node is connected to other signaling nodes;
(b) at least one signaling system that sends signaling messages to other signaling nodes or, respectively, receives signaling messages from said other signaling nodes, via said links;
characterized by:
(c) said signaling system respectively allocates a signaling network identity to a link;
(d) at least one link that is not connected to other signaling nodes but formed as a loop, what is referred to as a loop link;
whereby different signaling network identities are allocated to the loop link at an output and input side by the signaling system.

12. A signaling node according to claim 11, wherein said signaling system, with assistance of said loop link communicates signaling messages between at least two signaling systems contained in the signaling point.

13. A signaling node according to claim 11, wherein said signaling system generates internal load for test purposes with assistance of said loop link.

14. A signaling node according to claim 11, wherein said signaling system realizes an interworking communication with other networks with assistance of said loop link.

15. A signaling node according to claim 11, wherein said signaling system is a signaling system according to No. 7 and allocates a same network identifier to said loop link at the output and input side.

16. A method for signaling in a signaling node comprising:
allocating signaling network identities to links of a signaling node by a signaling system; and
allocating different signaling network identities at an output side and input side to a link as a loop link that is returned from the signaling node to the same signaling node in a loop.

17. A method according to claim 16, further comprising employing said loop link by said signaling system to communicate signaling messages between two further signaling systems of the signaling node having a respective interface.

18. A method according to claim 16, further comprising employing said loop link by said signaling system to generate load for test purposes.

19. A method according to claim 16, further comprising employing said loop link by said signaling to enable with other networks.

20. A method according to claim 16, further comprising allocating a common NI to said loop link at an output and input side by said signaling system.

21. A signaling node for processing signaling messages, comprising:
links via which the signaling node is connected to other signaling nodes;
at least one signaling system that either sends signaling messages to the other signal nodes or receives signaling messages from the other signaling nodes via said links;
wherein said signaling system allocates a signaling network identity to at least one of said links; and
wherein said signaling system allocates different signaling network identities to a loop link at an output side and input side for one of said links when said one of said links is returned in a loop to a signaling node.

22. A signaling node, comprising:
at least one signaling node;
a first internal network comprising a first unique network identity and a first ISUP;
a second internal network comprising a second unique network identity and a second ISUP;
a first signaling link associated with said first internal network;
a second signaling link associated with said second internal network;
at least one routing table configured with at least one of said first unique network identity and said second unique network identity; and
a loop link interconnecting said first internal network and said second internal network.

23. A method for signaling in a signaling node, comprising:
allocating unique point codes to each of a plurality of signaling networks interconnecting a plurality of signaling nodes; and
routing a signal from a first network of said plurality of signaling networks to a second network of said plurality of signaling networks using said unique point codes.

24. The signaling node according to claim 12, wherein a signaling system communicates signaling messages via said loop link between two signaling systems contained within the signaling node.

25. The signaling node according to claim 12, wherein a signaling system generates internal load for test purposes with assistance of said loop link.

26. The signaling node according to claim 12, wherein a signaling system realizes an interworking communication with other networks with assistance of said loop link.

27. The signaling node according to claim 12, wherein a signaling system is a signaling system according to Signaling System 7 and allocates a same network identifier to said loop link at the output and input side.

28. The signaling node according to claim 11, further comprising at least a second signaling system within said signaling node.
